(19) United States
(12) Patent Application Publication
(10) Pub. No.: US 2013/0167144 A1
(43) Pub. Date: Jun. 27, 2013

(54) Virtual Machine Persisted Within Itself

(71) Applicants: Bernd Mathiske, Sunnyvale, CA (US); Edwin Smith, Marlborough, MA (US); Mason Chang, Arcadia, CA (US)

(72) Inventors: Bernd Mathiske, Sunnyvale, CA (US); Edwin Smith, Marlborough, MA (US); Mason Chang, Arcadia, CA (US)

(21) Appl. No.: 12/554,597

(22) Filed: Sep. 4, 2009

(51) Int. Cl. G06F 9/455

(52) U.S. Cl. 718/1

(57) ABSTRACT

A computer-implemented method includes generating an intermediate representation of a virtual machine. The method includes generating an executable for the virtual machine. The method includes persisting at least part of the intermediate representation in the executable. A virtual machine tangibly stored in a computer-readable storage device, and a computer system, are also disclosed.

### BACKGROUND

This specification relates to virtual machines.

### SUMMARY

This specification describes technologies related to virtual machines.

In a first aspect, a computer-implemented method includes generating an intermediate representation of a virtual machine. The method includes generating an executable for the virtual machine. The method includes persisting at least part of the intermediate representation in the executable.

Implementations can include any or all of the following features. The method can further include receiving application code obtained from an application hosted by the virtual machine, the application written in another language than code for the virtual machine; translating the application code to a first application intermediate representation; performing inline replacement in the first application intermediate representation with the part of the intermediate representation that is persisted in the executable; and obtaining a second application intermediate representation as a result of the inline replacement. Only the part can be persisted in the virtual machine, and the method can further include selecting the part from the intermediate representation before persistence is performed, the part being selected based on the part being relevant for the inline replacement and a remainder of the intermediate representation not being relevant for the inline replacement. The inline replacement can be performed in a just-in-time compilation of the application code. The method can further include performing, in the virtual machine, a high-level optimization using the intermediate representation that modifies the application code and increases efficiency in executing the application code. The method can further include performing, in the virtual machine, a lowering operation that modifies the application intermediate representation; obtaining another application intermediate representation as a result of the lowering operation; and performing, in the virtual machine, a low-level optimization using the other application intermediate representation.

The virtual machine can be generated using code written in C++ language, and the application can be written in another language. The other language can be ActionScript language.

Persisting the part can include performing static linking of the part and the executable. The static linking can include generating an archive for files of the virtual machine; storing at least the executable in the archive; and storing a file corresponding to the part in the archive.

In a second aspect, a virtual machine tangibly stored in a computer-readable storage device includes inline replacement objects implemented in an intermediate representation of the virtual machine. The virtual machine includes a frontend receiving first code of an application hosted by the virtual machine. The virtual machine includes an inline replacer that places the inline replacement objects in the code at selected positions. The virtual machine includes a code generator generating second code in another language than the application.

Implementations can include any or all of the following features. The inline replacement objects can be selected for the virtual machine from the intermediate representation, the inline replacement objects being selected based on the inline replacement objects being relevant for the code and a remainder of the intermediate representation not being relevant for the code. The inline replacer can place the inline replacement objects in the code as part of a just-in-time compilation of the code. The virtual machine can further include a high-level optimizer performing a high-level optimization using the inline replacement objects that generates first modified code. The virtual machine can further include a lowering translator performing a lowering operation that generates second modified code from the first modified code; and a low-level optimizer performing a low-level optimization that generates third modified code from the second modified code. The virtual machine can be written in C++ language, and the code can be written in another language. The other language can be ActionScript language.

In a third aspect, a computer system includes a tool for receiving source code for a virtual machine. The computer system includes a static translator generating inline replacement objects, using the source code, in an intermediate representation of the virtual machine. The computer system includes a source code tool chain generating, using the source code, an executable for the virtual machine. The computer system includes a static linker that persists the inline replacement objects in the executable. The computer system includes a computer-readable storage device in which the computer system stores the executable including the inline replacement objects.

Implementations can include any or all of the following features. The virtual machine can be configured so that the inline replacement objects are placed in code of an application, hosted by the virtual machine, as part of a just-in-time compilation of the code. The computer system can select the inline replacement objects for the virtual machine from the intermediate representation, the inline replacement objects being selected based on the inline replacement objects being relevant for code of an application hosted by the virtual machine and a remainder of the first intermediate representation not being relevant for the code.

Particular embodiments of the subject matter described in this specification can be implemented to realize one or more of the following advantages. An improved virtual machine can be provided. At least part of a virtual machine can be persisted within itself. A semi-metacircular virtual machine can be provided. Inline replacement objects for a virtual machine can be generated by translating the virtual machine into an intermediate representation.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a system that can be used for development, execution, and distribution of a virtual machine.

FIG. 2 schematically shows a system that can be used for executing an application in a virtual machine.

FIG. 3 shows a system that can be used to create and execute a virtual machine for hosting an application.

FIG. 4 shows a process that can be used to compile a virtual machine application

Like reference numbers and designations in the various drawings indicate like elements.

### DETAILED DESCRIPTION

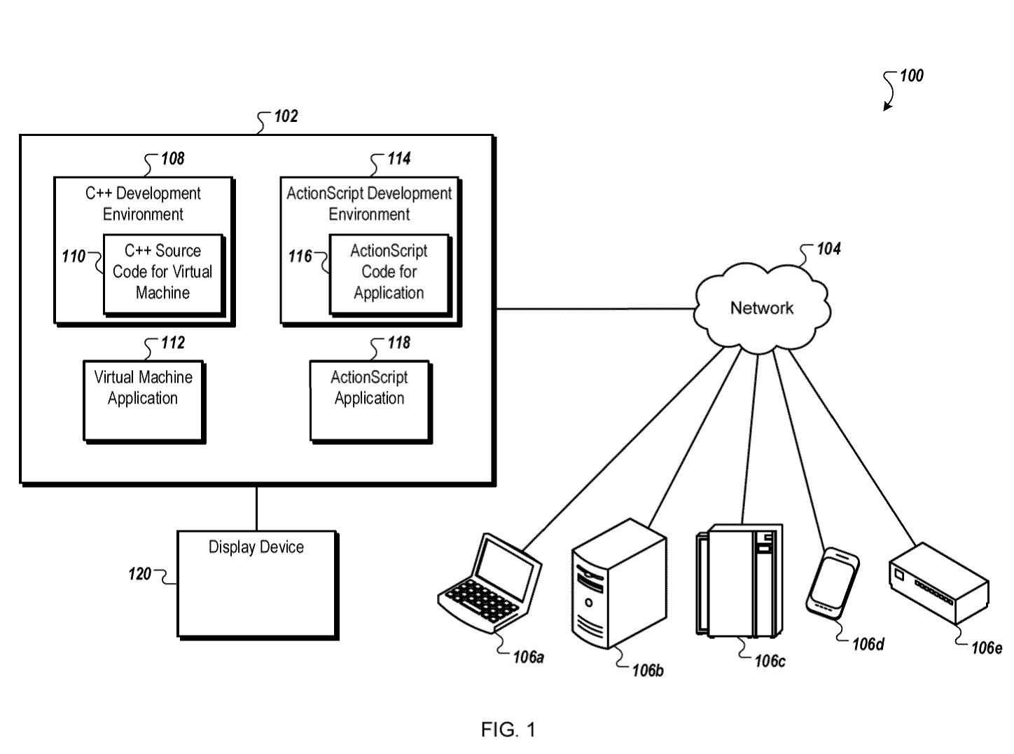

FIG. 1 shows a system 100 for development, execution, and distribution of a virtual machine (VM). The system 100 can include a development computer 102, a network 104, and one or more distribution devices 106 connected to the development computer 102 or to other systems by the network 104. In some implementations, the system 100 can provide functionality to develop, execute, and distribute also an application associated with a virtual machine. In examples below will be described that an internal representation of the VM can be persisted in an executable of the VM.

The development computer 102 can include one or more computers, systems and/or resources that can host development environments, VMs and/or applications. For example, the development computer 102 can include a laptop or personal computer with a mouse, keyboard, monitor and speakers. The development computer 102 can be used by a human developer to develop virtual machines and/or applications. In another example, the development computer 102 can include multiple work stations used by multiple human developers in different geographic areas. The work stations can be connected by a virtual private network (VPN) with a central shared resource server that provides services such as document management, email communications, etc.

The human developer can use the development computer 102 to develop a VM. VMs can host and execute applications. These applications can include code to interface with the host virtual machine. For example, applications can read and store data to VM memory, request settings information from the VM, read input and write output of the VM, and/or interact in other ways. When compiled, the code that executes the communication(s) in the application can be replaced inline with an inline replacement object. In some implementations, the VM can be generated such that at least part of the VM is persisted within itself. For example, a copy of the virtual machine can be included inside the VM. Such inline replacements can reduce the requirements of the virtual machine to respond to hosted applications and/or can permit the applications to execute more efficiently.

The development computer 102 can include a VM development environment 108 and/or an application development environment 114. The VM development environment 108 and the application development environment 114 can include computer-based development tools including, but not limited to, code editors, compilers, linkers, document managers, testing tools, specifications, automatic code generators. In some implementations, one or more integrated development environments (IDEs) can integrate multiple tools together.

The VM development environment can be used by a human developer to develop VM source code 110. In some embodiments, the VM source code 110 can be written in any language, for example C, C++, Java, an assembly language, another language, and/or a combination of languages. The VM source code 110 can include code, libraries, resources, and other objects not originally developed in the VM development environment 108. The VM source code 110 can be used to create a VM application 112, for example by compiling, translating, interpreting or other methods. The VM application 112 can be a software object that, when executed in the proper computing environment, can create a virtual machine within the environment. As an example, in the figure the development environment 108 is labeled a “C++” development environment and the source code 110 a “C++” source code.

The application development environment 114 can be used by a human developer to develop application source code 116. The application source code 116 can be written in a different language than the VM source code 110. In some embodiments, the application source code 116 can be written in any language, for example ActionScript, Java, LISP, an assembly language, and/or another languages or a combination of languages. The application source code 116 can include code, libraries, resources, and other objects not originally developed in the application development environment 114. The application source code 116 can be used to create an application 118, for example by compiling, translating, or interpreting the code, or using other methods. The application 118 can be a software object that can be executed in a virtual machine or other appropriate environment. As an example, in the figure the development environment 114 is labeled an “ActionScript” development environment, the code 116 an “ActionScript” code, and the application 118 an “ActionScript” application.

In some embodiments, the application source code 116 can be developed separately from the virtual machine source code 110. For example, the VM application 112 can be designed to be a VM to support a newly created programming language. The application 118 can be developed by another developer using a different development environment 114 in a different development computer 102 at a later date than the development environment 108 in the development computer 102 used to develop the VM application 112. In another example, the VM application 112 can be designed to be a hardware emulator that emulates a smart phone on a desktop computer. A different developer in the future wishing to develop the application 118 can test the application 118 with the VM application 112 before going to the trouble of loading the application 118 on a smart phone. In another example, the VM application 112 can be designed to replace a legacy hardware or software environment that is out of date, expensive, or hard to find. In this example, the application 118 can have been developed for the legacy environment and can predate the VM application.

The application 118 can be hosted or executed within the VM application 112. The VM application 112 can be executed, creating a VM environment that can include a just-in-time (JIT) compiler. The application 118 can be executed within the VM environment and executed by the JIT compiler. In some implementations, the JIT compiler can further compile, interpret, or translate the application 118 during execution. In one example, the VM application 112 can be executed in the development computer 102, and the application 118 can be executed in the VM environment in the development computer 102. Output from the execution, such as text, sound, and/or graphical objects can be output from the development computer 102 by display device 120. The display device 120 can be hardware or software components, such as monitors, speakers, network connections, or other object for handling output.

The VM application 112 and/or the application 118 can be distributed to one or more of the distribution devices 106. The VM application 112 and/or the application 118 can be distributed through the network 104, such as a computer network like the internet, through a retail distribution network using digital versatile discs (DVDs) or compact disks (CDs), or other types of networks. The distribution devices 106 can receive and execute the VM application 112 and can receive and execute the application 118 in the VM environment. In some implementations, the VM application 112 can be executed on some or all of the distribution devices 106. Example distribution devices 106 include, but are not limited to, a personal computer 106a, a network server 106b, a legacy computer device 106c, a cellular phone 106d, and/or a console gaming system 106e. In some implementations, the legacy computer device 106c can be a device that is difficult or expensive to replace but accessible for programming purposes. Some such legacy computer devices 106c can include mining robots, control devices in satellites, and infrastructure hardware such as traffic lights and power plants. Incorporating a new VM to legacy devices 106c can upgrade the functionality of the legacy devices 106c without requiring a change in the hardware.

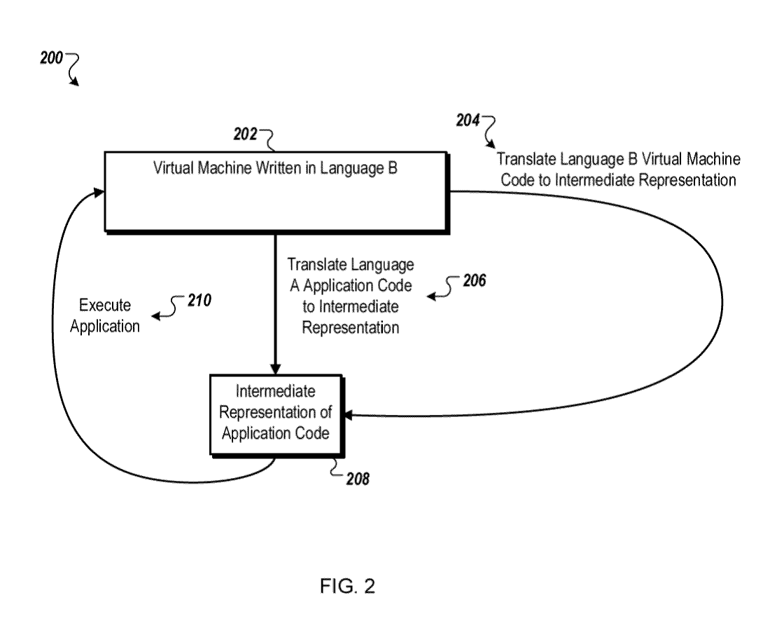

FIG. 2 schematically shows a system 200 that can be used for executing an application in a VM. In some implementations, code that implements a VM and/or an application can be compiled into different formats. First, development code is code that can be written by a human developer to create software objects such as modules and applications. Development code can be designed so that it is human-readable with relatively little training. Some examples of development code include, but are not limited to, C, C++, ActionScript, Java, and Lisp. In the example below, the development code for an application is assumed to be written in language A.

Second, intermediate representations (IRs) of code can be created by compiling or partly compiling development code or another IR. IR of development code can contain the same overall functionality of development code, but can be structured differently and/or perform different specific functions in different orders. In some examples, different development languages can be compiled into the same IR languages. In some implementations, a development language can be compiled into more than one IR language.

IRs can be edited to improve and or optimize the performance of the IR. Inline replacement is one method of editing an IR. A section of an IR created from compiled development code can be replaced with an object known or expected to perform the same functionality as the replaced section. For example, an IR of an application can include a routine that queries an operating system for a list of available network services, that reads incoming network traffic, and that stores a part of the network traffic to memory. This routine can impose relatively significant system costs if executed. If an object that can perform these functions without requiring as many system resources is available, the object can replace the routine. Other methods of editing an IR can include flow analysis and improvement and caching frequently used data.

Third, machine code can include hardware instructions created by compiling IRs for a particular hardware instruction set. Machine code can directly interact with and command hardware such as a central processing unit (CPU), random access memory (RAM), and/or other hardware. Machine code created from an IR can have the same overall functionality as the IR and development code it is compiled from. Machine code can be indecipherable to humans without special training.

A VM 202 can be implemented in an operating system environment. The VM 202 can be written in a development language, such as C++, which will here be referred to as language B, to distinguish it from the language A of the application. The VM 202 development code can be used in generating a VM executable file which can be executed in the operating system environment. A copy of some or all of the VM development code in development language B can also be translated 204 into a VM IR, having a language AIR. The VM IR of language AIR can be accessible by the VM 202. In some implementations, the AIR language can be one that development language B is not usually compiled into. The VM IR can be persisted in the VM executable file and be used, as an example, for inline replacement in JIT compilation.

The VM 202 can host and execute, such as by just-in-time execution, the application written in development language A, such as ActionScript. The VM 202 can translate 206 the application written in development language A into an application IR 208 of language AIR. The application IR 208 can be edited, such as by receiving inline replacements of objects from the VM IR. After receiving the inline replacements, the application IR 208 can be executed 210 in the VM 202.

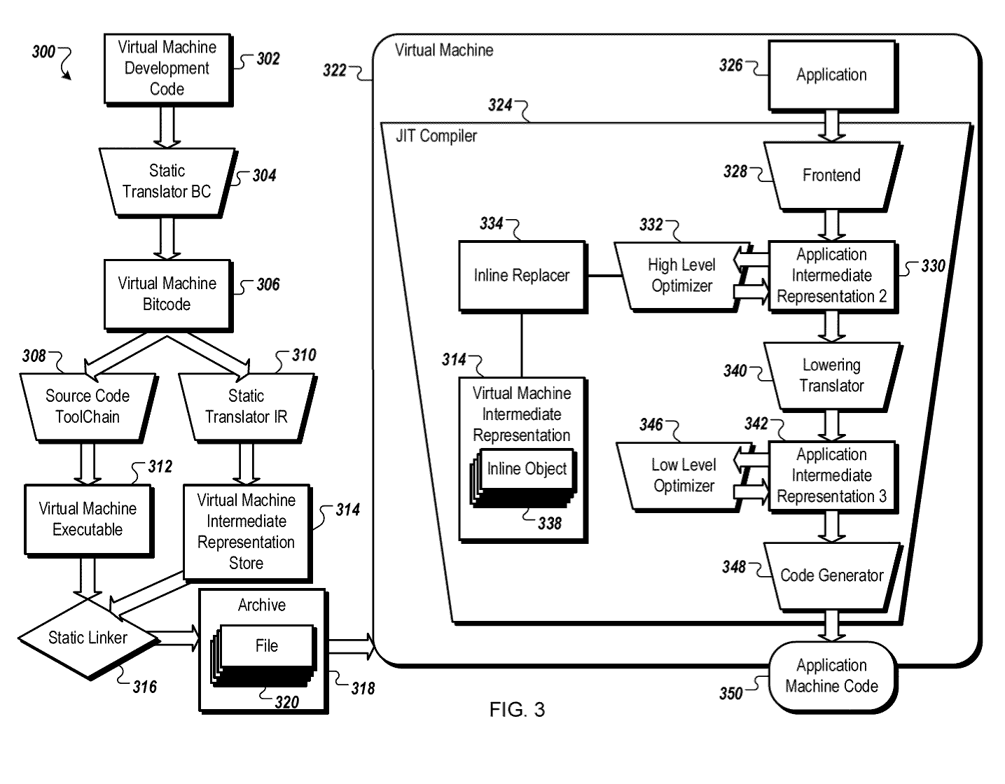

FIG. 3 shows a system 300 that can be used to create and execute a VM that can execute an application. Examples below will describe that the system 300 can use the VM development code 302 to generate a VM executable, wherein a portion or all of an internal representation of the VM is persisted within the VM executable.

A static translator BC 304 can translate the VM development code 302 into VM bitcode 306. Any translator compatible with the development language of the code 302 can be used. The VM bitcode 306 can be an IR of the VM development code 302.

The VM bitcode 306 can be translated by a source code toolchain 308 into an VM executable 312. The source code toolchain 308 can be a series of tools linked together to perform a task such as code compilation.

The VM bitcode 306 can be translated by a static translator IR 310 into an IR store 314. In various implementations, the IR store 314 can be created before, after, or concurrent with the VM executable 312. In some implementations, the IR store 314 can be a subset or partial translation of the VM bitcode 306. In these implementations, the subset or partial translation can be selected, for example, as being relevant for inline replacements of executing applications. In some implementations, the IR store 314 can be additionally processed, for example by the static translator IR 310, to alter the IR store 314. For example, the file format and/or file extension of the file in the VM IR store 314 can be changed.

In some implementations, the source code toolchain 308 can include, or be included in a toolchain for, the static translator 310. That is, in some implementations the same toolchain can be used for generating the VM executable 312 as for generating the IR store 314. In other implementations, the source code toolchain 308 can be separate from the toolchain for the static translator 310.

A static linker 316 can statically link the VM executable 312 and the IR store 314. The linking causes the VM executable to have at least part of the VM IR persisted within itself. For example, the static linker 316 can create an archive 318 that can contain one or more files 320 of the VM executable 312 and the IR store 314. The archive 318 can include one or more additional files 320 such as index, manifest, readme, and/or other files. The archive 318 can be a single executable file that, when executed, can create a VM 322. The VM 322 can have access to the files 320, including the files of the IR store 314.

The VM 322 can host an application 326 for execution with a just in time (JIT) compiler 324. The JIT compiler 324 can receive the application 326, in the form of development code or an IR, and compile the application 326 as the JIT compiler 324 executes the application 326. The JIT compiler 324 can compile a section of the application 326 at a time, such as a predetermined number of lines of code, a function, a file, and/or another type of section. As the JIT compiler 324 executes the application 326, the JIT compiler 324 can modify the application 326 to improve performance.

The JIT compiler 324 can include a frontend 328 that can receive the application 326. The application 326 can be translated into an IR2 330 which can be in the same IR language as the IR store 314 and a different language than the application 326. A high level optimizer 332 in the JIT compiler 324 can edit the IR2 330, for example to increase efficiency in execution of the application 326. The high level optimizer 332 can use an inline replacer 334 to perform inline replacements on the IR2 330. The inline replacer 336 can have access to a copy of, or a reference to, the IR store 314 including inline objects 338 within the IR store 314. For example, one or more functions, variables, constants, or other data of the IR2 330 can be replaced with inline objects 338 to replace or reduce system calls from the IR2 330 to the VM 322, reduce communication delay, or alter the format of the IR2 330 in preparation for later editing. In one implementation, a code generator 348 can translate the IR2 330 to application machine code 350. In such implementations, the high level optimizer 332 of the components described above can be omitted, for example. Application machine code 350 can include machine level instructions and may be executable in the same environment as the VM 322. The application machine code 350 can be executed while the application 326 is being compiled and/or may be stored to a computer readable medium such as a hard disk, CD, or DVD, to name a few examples.

In another implementation, a lowering translator 340 can translate the IR2 330 to an IR3 342. In some implementations, the lowering translator 340 can translate the IR2 330 to a lower level, or more machine code-like, IR language. In some implementations, the IR3 can include objects that describe machine instructions, but are not machine instructions. For example, an instruction in the IR3 342 can move information into memory without specifying a bit pattern to use. A low level optimizer 346 can edit the IR3 342. For example, results of repeated memory commands can be identified and cached. In this implementation, the code generator 348 can translate the IR3 342 to application machine code 350.

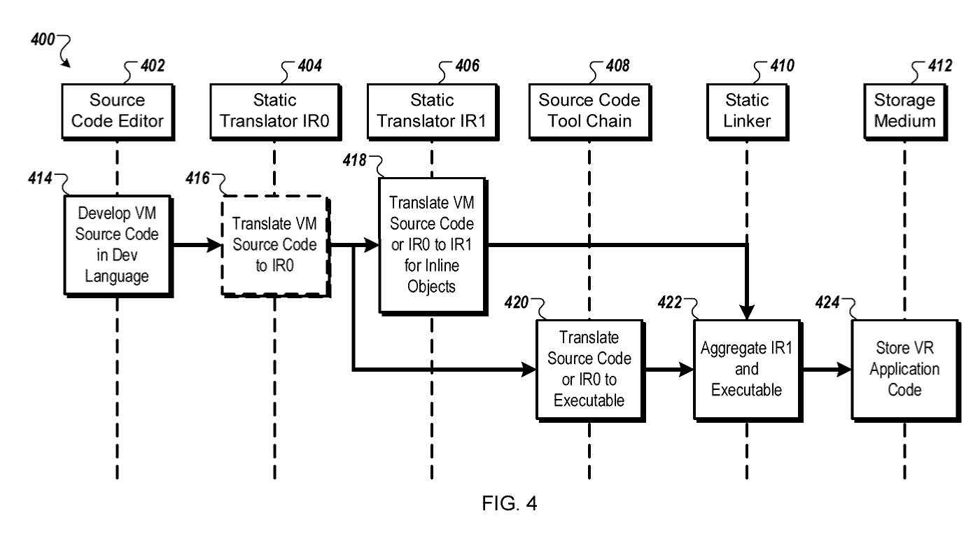

FIG. 4 shows a diagram of a process 400 that can be used to compile a virtual machine application.

A source code editor 402 can include a computer application used by a human developer to create source code. For example, a human developer can use the source code editor 402 to develop 414 source code for a VM in a development language.

A static translator IR0 404 can receive development code and translate development code to an IR. For example, the static translator IR0 404 can receive 416 VM development code and translate 416 the development code into an IR0.

A static translator IR1 406 can receive development code and/or IRs and translate it/them to an IR. For example, the static translator IR1 406 can receive 418 either an IR from the static translator IR0 404 or development source code from the source code editor 402 and create 418 an IR1 for inline objects. The IR1 can be in the same IR language as that to which a JIT compiler translates code for an application hosted by the VM. In some embodiments, a portion of the received IR or development code can be excluded from the translation if the portion is unrelated to inline replacements.

A source code tool chain 408 can receive development code and/or IRs and translate it/them to an executable. For example, the source code tool chain 408 can receive 420 either an IR from the static translator IR0 404 or development source code from the source code editor 402 and create 420 an executable. The source code tool chain 408 can include, or be included in a tool chain for, the static translator IR1 406. As another example, the static translator IR1 406 can be included in another tool chain than the source code tool chain 408.

A static linker 410 can link files and create archives containing the files. For example, the static linker 410 can receive and combine 422 an IR from the static translator IR1 406 and an executable from the source code tool chain 408 and create 422 an archive file containing the IRs.

A storage medium 412 can receive files and store files. For example, the storage medium 412 can receive an archive file from the static linker 410 store 424 the archive file. Any computer-readable storage medium can be used, in some implementations.

Some portions of the detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, a blu-ray player, a television, a set-top box, or other digital devices.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, an infrared (IR) remote, a radio frequency (RF) remote, or other input device by which the user can provide input to the computer. Inputs such as, but not limited to network commands or telnet commands can be received. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
generating, from source code, an intermediate representation that corresponds to a virtual machine;
generating an executable for the virtual machine by compiling the intermediate representation; and
persisting at least part of the intermediate representation in the executable.

2. The method of claim 1, further comprising:
receiving application code for an application hosted on the virtual machine, the application written in a language other than the source code for the virtual machine;
translating the application code to a first application intermediate representation;
performing inline replacement in the first application intermediate representation with the part of the intermediate representation that is persisted in the executable; and
obtaining a second application intermediate representation as a result of the inline replacement.

3. The method of claim 2, wherein the part is persisted in the virtual machine, the method further comprising:
selecting the part from the intermediate representation before persistence is performed, the part being selected based on the part being relevant for the inline replacement and a remainder of the intermediate representation not being relevant for the inline replacement.

4. The method of claim 2, wherein the inline replacement is performed in a just-in-time compilation of the application code.

5. The method of claim 2, further comprising:
performing, in the virtual machine, a high-level optimization using the intermediate representation that modifies the application code and increases efficiency in executing the application code.

6. The method of claim 5, further comprising:
performing, in the virtual machine, a lowering operation that modifies the application intermediate representation;
obtaining a second application intermediate representation as a result of the lowering operation; and
performing, in the virtual machine, a low-level optimization using the second application intermediate representation.

7. The method of claim 1, wherein the source code is written in C++ language, and the application is written in another language.

8. The method of claim 7, wherein the other language is ActionScript language.

9. The method of claim 1, wherein persisting the part comprises performing static linking of the part and the executable.

10. The method of claim 9, wherein the static linking comprises:
generating an archive for files of the virtual machine;
storing at least the executable in the archive; and
storing a file corresponding to the part in the archive.

11. A virtual machine stored in a computer-readable storage device, the virtual machine comprising:
inline replacement objects implemented in an intermediate representation that corresponds to the virtual machine;
a frontend that receives source code of an application hosted by the virtual machine and translates the source code to a first code;
an inline replacer that places the inline replacement objects in the first code at selected positions; and
a code generator that compiles the second code to generate an executable to be hosted on the virtual machine.

12. The virtual machine of claim 11, wherein the inline replacement objects are selected from the intermediate representation, the inline replacement objects being selected based on the inline replacement objects being relevant for the first code and a remainder of the intermediate representation not being relevant for the first code.

13. The virtual machine of claim 11, wherein the inline replacer places the inline replacement objects in the first code as part of a just-in-time compilation of the code.

14. The virtual machine of claim 11, further comprising:
a high-level optimizer performing a high-level optimization using the inline replacement objects to generate a first modified code.

15. The virtual machine of claim 14, further comprising:
a lowering translator performing a lowering operation that generates a second modified code from the first modified code; and
a low-level optimizer performing a low-level optimization that generates a third modified code from the second modified code.

16. The virtual machine of claim 11, wherein the virtual machine is written in C++ language, and the source code is written in another language.

17. The virtual machine of claim 16, wherein the other language is ActionScript language.

18. A computer system comprising:
a tool for receiving source code for a virtual machine, the source code being in a different language than application source code for an application hosted on the virtual machine;
a static translator generating, based on the source code, virtual machine bitcode in an intermediate representation (IR);
a static translator generating inline replacement objects in an intermediate representation, from the virtual machine bitcode, that corresponds to the virtual machine and storing the replacement objects in an IR store, the IR store being a subset of the virtual machine bitcode and the subset being used for inline replacements of executing applications;
a source code tool chain generating, from the virtual machine bitcode, an executable for the virtual machine by compiling the intermediate representation;
a static linker that persists the inline replacement objects in the executable; and
a computer-readable storage device in which the computer system stores the executable including the inline replacement objects.

19. The computer system of claim 18, wherein the virtual machine is configured so that the inline replacement objects are placed in code of the application, as part of a just-in-time compilation of the code of the application.

20. The computer system of claim 18, wherein the computer system selects the inline replacement objects for the virtual machine from the intermediate representation, the inline replacement objects being selected based on the inline replacement objects being relevant for code of the application and a remainder of the first intermediate representation not being relevant for the code.
